(19) United States
(12) Patent Application Publication
(10) Pub. No.: US 2019/0071109 A1
(43) Pub. Date: Mar. 7, 2019

(54) CART MOUNTED CUP HOLDER

(71) Applicant: Walmart Apollo, LLC, Bentonville, AR (US)

(72) Inventors: Yurgis Mauro Bacallao, Centerton, AR (US); Joel Larson, Rogers, AR (US); Bridget Leffler, Bentonville, AR (US); Joshua David Osmon, Bentonville, AR (US)

(21) Appl. No.: 16/122,199

(22) Filed: Sep. 5, 2018

Related U.S. Application Data
(60) Provisional application No. 62/555,532, filed on Sep. 7, 2017.

(51) Int. Cl. B62B 3/14

(52) U.S. Cl. CPC B62B 3/1472; B62B 2202/023

(57) ABSTRACT

Provided is a cart mounted cup holder. The cup holder includes a support bracket having a mounting member, a connecting member, a horizontal member and a vertical member. The connecting member is coupled between the mounting member and the horizontal member such that an interior angle between the horizontal member and the mounting member is an acute angle. The vertical member is coupled to the horizontal member and is substantially perpendicular to the horizontal member. The cup holder also includes a cup retaining member coupled to an end of the vertical member, wherein the cup retaining member is perpendicular to the vertical member and substantially parallel with the horizontal member. The cup retaining member has an aperture for receiving a cup there through, wherein the cup is supported by the horizontal member when received through the cup retaining member.

This application claims priority to U.S. Provisional Patent Application entitled “CART MOUNTED CUP HOLDER,” Ser. No. 62/555,532, filed Sep. 7, 2017, the disclosure of which is hereby incorporated entirely herein by reference.

### FIELD OF THE INVENTION

The invention relates generally to a cup holder, and more specifically, to a cart mounted cup holder.

### BACKGROUND

Customers are more consistently having beverages that they carry during shopping within a store. Shopping carts exist with cup holders that are typically always available and are in a fixed position with the cart. The existing cup holder systems are also lacking in the ability to retrofit existing carts with the cup holder system.

### BRIEF SUMMARY

In one aspect, provided is a cart mounted cup holder, comprising: a support bracket having a mounting member, a connecting member, a horizontal member and a vertical member, wherein: the connecting member is coupled between the mounting member and the horizontal member such that an interior angle between the horizontal member and the mounting member is an acute angle; and the vertical member is coupled to the horizontal member and is substantially perpendicular to the horizontal member; and a cup retaining member coupled to an end of the vertical member, wherein the cup retaining member is perpendicular to the vertical member and substantially parallel with the horizontal member, the cup retaining member having an aperture for receiving a cup there through, wherein the cup is supported by the horizontal member when received through the cup retaining member.

In another aspect, provided is a cart mounted cup holder, comprising: a support bracket having a mounting member, connecting member, a horizontal member and a vertical member, wherein: the connecting member is coupled between the mounting member and the horizontal member such that an interior angle between the horizontal member and the mounting member is an acute angle; and the vertical member is coupled to the horizontal member and is substantially perpendicular to the horizontal member; and a cup retaining member coupled to an end of the vertical member, wherein the cup retaining member is perpendicular to the vertical member and substantially parallel with the horizontal member, the cup retaining member having an aperture for receiving a cup there through, wherein the cup is supported by the horizontal member when received through the cup retaining member.

Yet, in another aspect, provided is a shopping cart with a cart mounted cup holder, comprising: the cup holder coupled to the shopping cart, wherein the cup holder comprises: a support bracket having a mounting member, a connecting member, a horizontal member and a vertical member, wherein: the connecting member is coupled between the mounting member and the horizontal member such that an interior angle between the horizontal member and the mounting member is an acute angle; the mounting member is coupled to a rear portion of the shopping cart, wherein the acute interior angle between the horizontal member and the mounting member maintain the horizontal member substantially parallel to a surface of travel of the cart; and the vertical member is coupled to the horizontal member and is substantially perpendicular to the horizontal member; and a cup retaining member coupled to an end of the vertical member, wherein the cup retaining member is perpendicular to the vertical member and substantially parallel with the horizontal member, the cup retaining member having an aperture for receiving a cup there through, wherein the cup is supported by the horizontal member when received through the cup retaining member.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of a cup holder for mounting to a shopping cart, in accordance with some embodiments.

FIG. 2 is another perspective view of a cup holder for mounting to a shopping cart, in accordance with some embodiments.

FIG. 3 is a front view of a cup holder for mounting to a shopping cart, in accordance with some embodiments.

FIG. 4 is a rear view of a cup holder for mounting to a shopping cart, in accordance with some embodiments.

FIG. 5 is a left side view of a cup holder for mounting to a shopping cart, in accordance with some embodiments.

FIG. 6 is a right side view of a cup holder for mounting to a shopping cart, in accordance with some embodiments.

FIG. 7 is a top view of a cup holder for mounting to a shopping cart, in accordance with some embodiments.

FIG. 8 is a bottom view of a cup holder for mounting to a shopping cart, in accordance with some embodiments.

FIG. 9 is a perspective view of a cup holder mounted to a shopping cart, in accordance with some embodiments.

### DETAILED DESCRIPTION

Many store customers prefer to shop while having a beverage during the shopping experience. These customers generally bring their own drinks or further bring drinks for their kids that are shopping with them. These drinks are often balanced within the cart, either in the main cart portion or by unfolding the child seat and balancing the drink on the child seat of the shopping cart.

The present inventive concepts combine the benefits of utilizing a shopping cart during shopping while also providing a cup holder that is retro fitted to the shopping cart and available to the customer at all times without inhibiting the customers use of the handle of the shopping cart or the child seat.

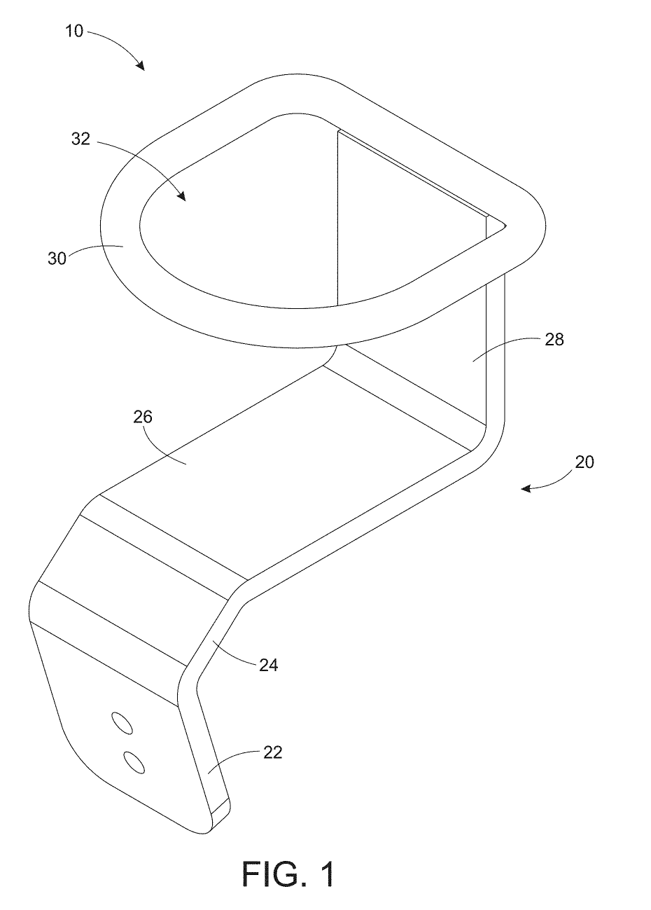

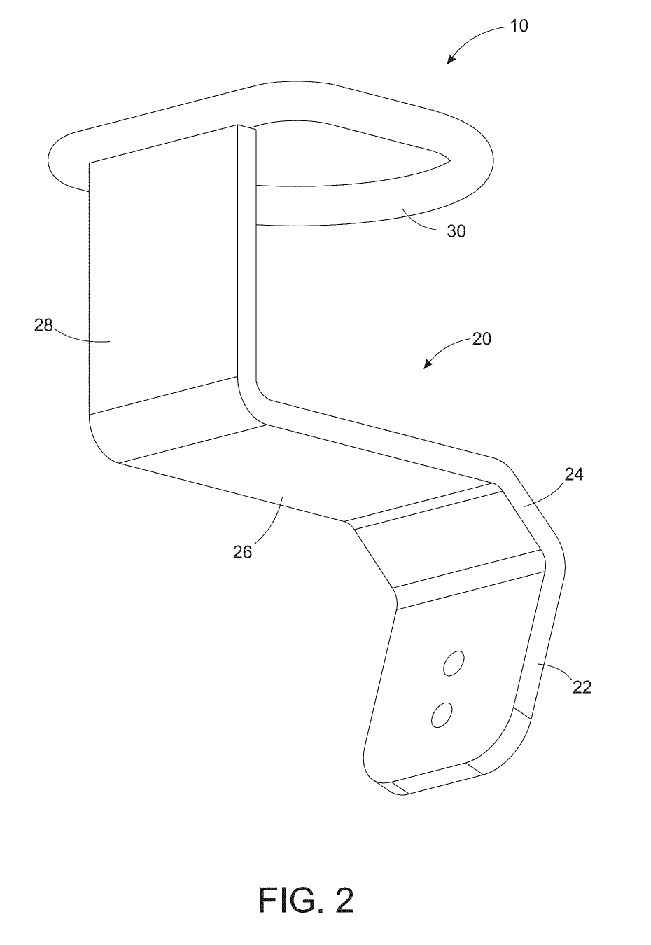

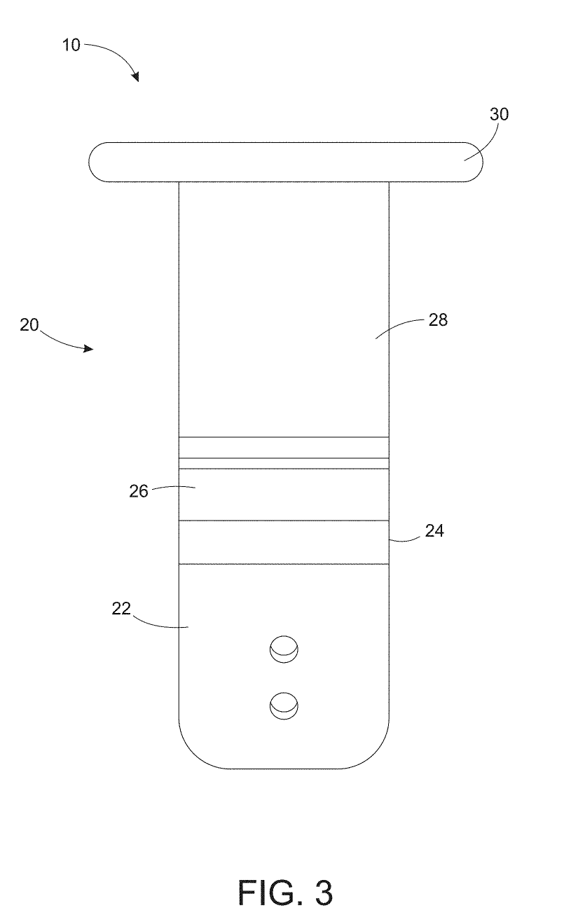

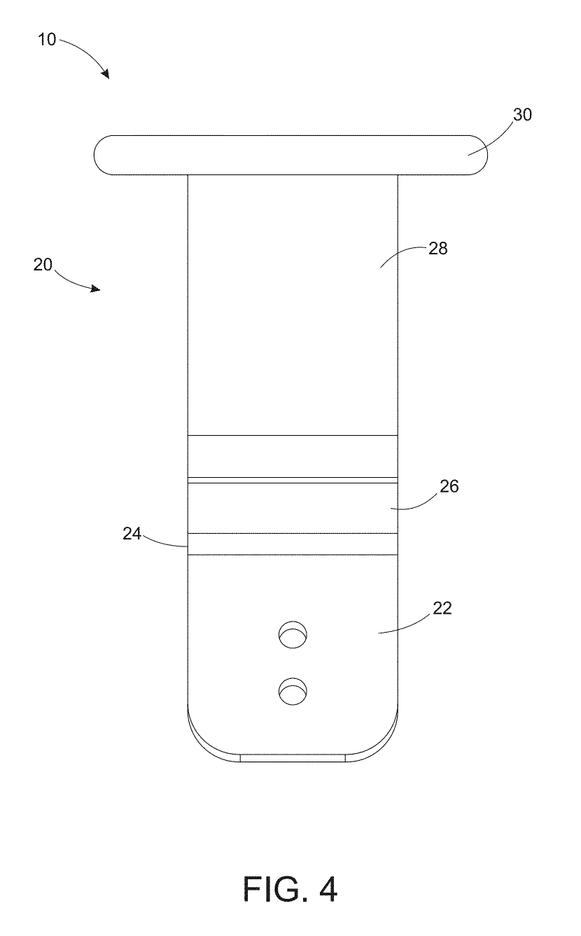

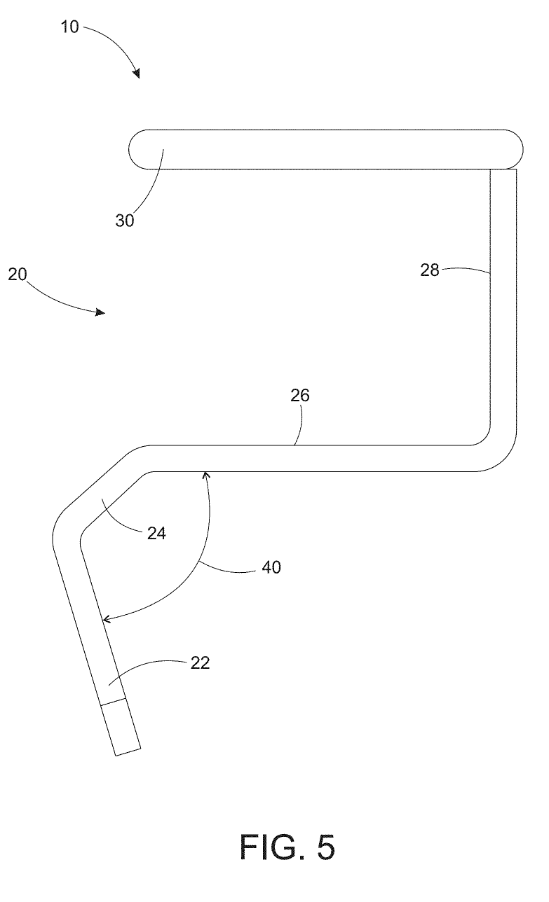

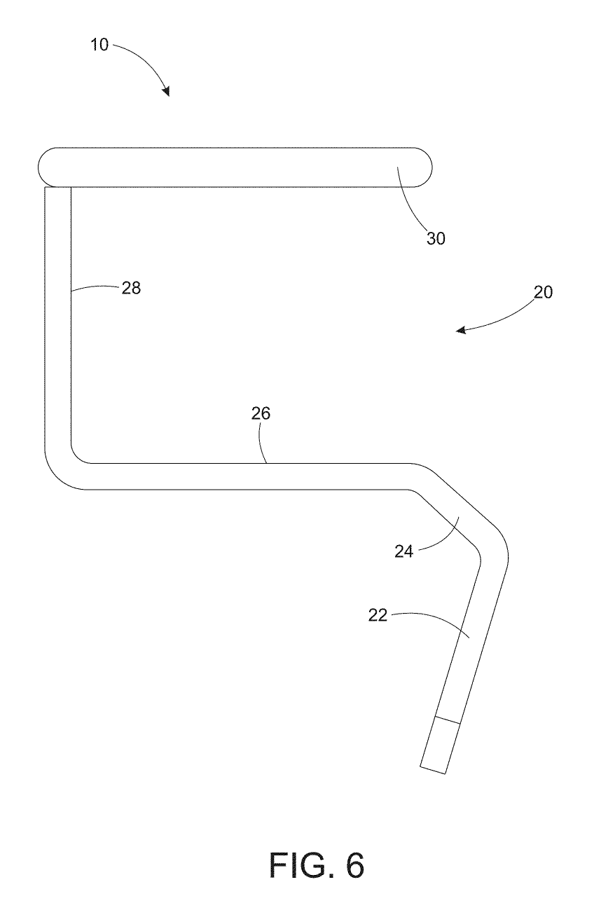

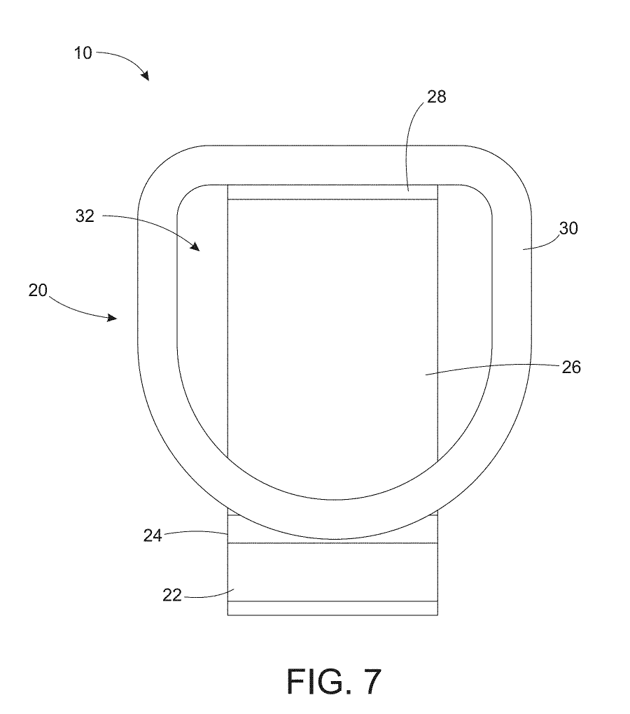

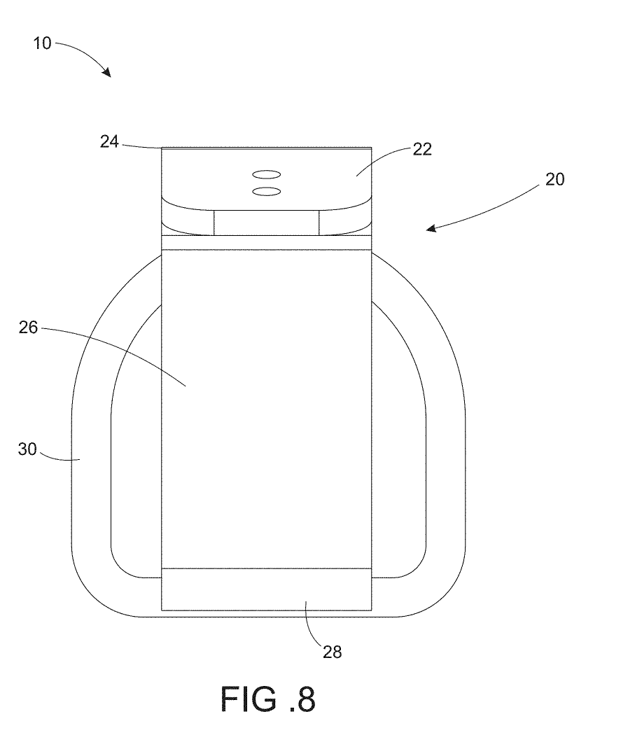

FIGS. 1-8 depict various views of a cup holder 10 for mounting to a shopping cart, in accordance with an embodiment. The cup holder 10 may include a support bracket 20 and a cup retaining member 30. The support bracket 20 may include a mounting member 22, a connecting member 24, a horizontal member 26 and a vertical member 28. The connecting member 24 may be coupled between the mounting member 22 and the horizontal member 26 such that an interior angle 40 between the horizontal member 26 and the mounting member 22 is an acute angle, or in other words, an angle less than ninety degrees. The vertical member 28 may be coupled to the horizontal member 26 and is substantially perpendicular to the horizontal member 26. As shown in FIGS. 1-8 the support bracket 20 may be formed as a unitary body; however, it will be understood that other embodiments may include each component of the support bracket 20 as independent components that are coupled together to form the support bracket 20.

The cup retaining member 30 may be coupled to an end of the vertical member 28 to maintain the cup retaining member 30 in a position perpendicular to the vertical member 28 and substantially parallel with the horizontal member 26. The distance between the horizontal member 26 and the cup retaining member 30 is substantially equal to the length of the vertical member 28. The cup retaining member 30 may include an aperture 32 for receiving a cup there through. The aperture 32 of the cup retaining member 30 may have a partial obround shape for receiving and retaining various types and sizes of cups and bottles within the aperture 32. The cup may be supported by the horizontal member 26 when received through aperture 32 of the cup retaining member 30. The cup retaining member 30 operates to maintain the cup resting on the horizontal member 26 while inhibiting tipping of the cup.

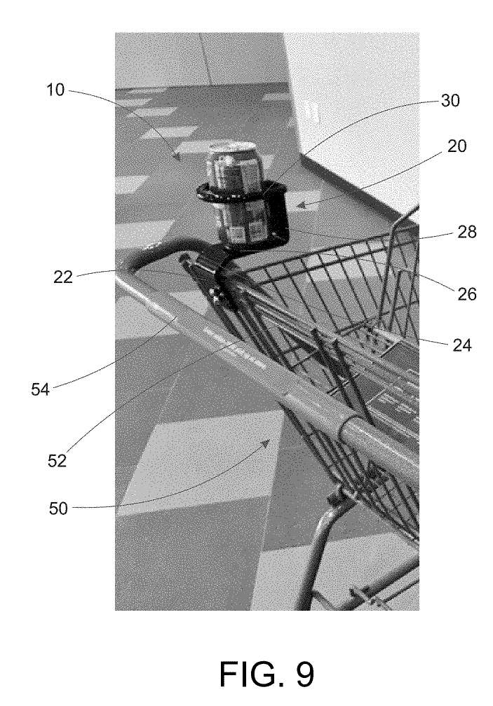

In embodiments, as depicted in FIG. 9, the mounting member 26 may be coupled to a rear portion 52 of a shopping cart 50 adjacent a handle 54. The interior angle between the mounting member 22 and the horizontal member 26 corresponds with an angle of the rear portion 52 of the cart 50 to orient the horizontal member 26 substantially parallel with a surface of travel of the cart. In at least way, the acute interior angel between the mounting member 22 and the horizontal member 26, when the mounting member 22 is coupled to a rear portion 52 of the shopping cart 50, operate to maintain the horizontal member 26 substantially parallel to a surface of travel of the cart during use of the shopping cart 50.

As will be appreciated by one skilled in the art, the components defining any cup holder for mounting to a cart may be formed of any of many different types of materials or combinations thereof that can readily be formed into shaped objects provided that the components selected are consistent with the intended operation of a zoning tool. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any cup holder for mounting to a cart may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While the invention has been shown and described with reference to specific preferred embodiments, it should be understood by those skilled in the art that various changes in form and detail may be made therein without departing from the spirit and scope of the invention as defined by the following claims.

What is claimed is:

1. A cart mounted cup holder, comprising:
a support bracket having a mounting member, a connecting member, a horizontal member and a vertical member, wherein:
the connecting member is coupled between the mounting member and the horizontal member such that an interior angle between the horizontal member and the mounting member is an acute angle; and
the vertical member is coupled to the horizontal member and is substantially perpendicular to the horizontal member; and
a cup retaining member coupled to an end of the vertical member, wherein the cup retaining member is perpendicular to the vertical member and substantially parallel with the horizontal member, the cup retaining member having an aperture for receiving a cup there through, wherein the cup is supported by the horizontal member when received through the cup retaining member.

2. The cup holder of claim 1, wherein the mounting member is coupled to a rear portion of a cart adjacent a handle, wherein the interior angle between the mounting member and the horizontal member corresponds with an angle of the rear portion of the cart to orient the horizontal member substantially parallel with a surface of travel of the cart.

3. The cup holder of claim 1, wherein the support bracket is formed as a unitary body.

4. The cup holder of claim 1, wherein the aperture of the cup retaining member has a partial obround shape for receiving and retaining various types and sizes of cups and bottles within the aperture.

5. The cup holder of claim 1, wherein a distance between the horizontal member and the cup retaining member is substantially equal to a length of the vertical member.

6. The cup holder of claim 1, wherein the cup retaining member operates to maintain the cup resting on the horizontal member while inhibiting tipping of the cup.

7. A cart mounted cup holder, comprising:
a support bracket having a mounting member, a connecting member, a horizontal member and a vertical member, wherein:
the connecting member is coupled between the mounting member and the horizontal member such that an interior angle between the horizontal member and the mounting member is an acute angle; and
the vertical member is coupled to the horizontal member and is substantially perpendicular to the horizontal member; and
a cup retaining member coupled to an end of the vertical member, wherein the cup retaining member is perpendicular to the vertical member and substantially parallel with the horizontal member, the cup retaining member having an aperture for receiving a cup there through, wherein the cup is supported by the horizontal member when received through the cup retaining member.

8. The cup holder of claim 7, wherein the mounting member is coupled to a rear portion of a cart adjacent a handle, wherein the interior angle between the mounting member and the horizontal member corresponds with an angle of the rear portion of the cart to orient the horizontal member substantially parallel with a surface of travel of the cart.

9. The cup holder of claim 7, wherein the aperture of the cup retaining member has a partial obround shape for receiving and retaining various types and sizes of cups and bottles within the aperture.

10. The cup holder of claim 7, wherein a distance between the horizontal member and the cup retaining member is substantially equal to a length of the vertical member.

11. The cup holder of claim 7, wherein the cup retaining member operates to maintain the cup resting on the horizontal member while inhibiting tipping of the cup.

12. A shopping cart with a cart mounted cup holder, comprising:
the cup holder coupled to the shopping cart, wherein the cup holder comprises:
a support bracket having a mounting member, a connecting member, a horizontal member and a vertical member, wherein:
the connecting member is coupled between the mounting member and the horizontal member such that an interior angle between the horizontal member and the mounting member is an acute angle;
the mounting member is coupled to a rear portion of the shopping cart, wherein the acute interior angle between the horizontal member and the mounting member maintain the horizontal member substantially parallel to a surface of travel of the cart; and
the vertical member is coupled to the horizontal member and is substantially perpendicular to the horizontal member; and
a cup retaining member coupled to an end of the vertical member, wherein the cup retaining member is perpendicular to the vertical member and substantially parallel with the horizontal member, the cup retaining member having an aperture for receiving a cup there through, wherein the cup is supported by the horizontal member when received through the cup retaining member.

13. The shopping cart with a cart mounted cup holder of claim 12, wherein the interior angle between the mounting member and the horizontal member corresponds with an angle of the rear portion of the shopping cart to orient the horizontal member substantially parallel with the surface of travel of the shopping cart.

14. The shopping cart with a cart mounted cup holder of claim 12, wherein the support bracket is formed as a unitary body.

15. The shopping cart with a cart mounted cup holder of claim 12, wherein the aperture of the cup retaining member has a partial obround shape for receiving and retaining various types and sizes of cups and bottles within the aperture.

16. The shopping cart with a cart mounted cup holder of claim 12, wherein a distance between the horizontal member and the cup retaining member is substantially equal to a length of the vertical member.

17. The shopping cart with a cart mounted cup holder of claim 12, wherein the cup retaining member operates to maintain the cup resting on the horizontal member while inhibiting tipping of the cup.
